(19) United States
(12) Patent Application Publication
(10) Pub. No.: US 2026/0360121 A1
(43) Pub. Date: Nov. 12, 2026

(54) TEXT GENERATION METHOD, ELECTRONIC DEVICE, AND COMPUTER-READABLE STORAGE MEDIUM

(71) Applicant: MASHANG CONSUMER FINANCE CO., LTD., Chongqing (CN)

(72) Inventor: Junzhi FAN, Chongping (CN)

(21) Appl. No.: 19/428,692

(22) Filed: Dec. 22, 2025

(30) Foreign Application Priority Data
May 8, 2025 (CN) 202510603033.3

(51) Int. Cl. G06V 10/77; G06T 3/40; G06V 10/80; G06V 10/82

(52) U.S. Cl. CPC G06V 10/7715; G06T 3/40; G06V 10/806; G06V 10/82

(57) ABSTRACT

A text generation method includes: multi-scale scaling processing is performed on first image to obtain second images, and feature extraction processing is performed on each second image to obtain features of each second image; channel shuffle processing is performed on channels of first features to obtain first processing result of first features, and channel shuffle processing is performed on channels of second feature to obtain second processing result of second feature; fusion processing is performed on first processing result and second processing result to obtain third feature, and third feature is mapped to a same feature space as first feature to obtain fourth features corresponding to first features; fusion processing is performed on the fourth features corresponding to the first features based on weights of the first features to obtain fifth feature; and second text is generated based on the fifth feature and first text corresponding to the first image.

### CROSS-REFERENCE TO RELATED APPLICATION

This application claims the benefit of priority of Chinese Patent Application No. 202510603033.3 filed on May 8, 2025, the contents of which are incorporated herein by reference in its entirety for all purposes.

### BACKGROUND

In related technologies, a single image is connected to a large language model through visual coding and a multi-layer perceptron, thereby integrating image information with the language model to achieve better document understanding and generation. However, a question answering task for a single-scale image can only generate an answer based on image information of a current scale, resulting in low accuracy of the generated answer.

### SUMMARY

Embodiments of the disclosure provide a text generation method, an electronic device, and a computer-readable storage medium.

The technical solutions of the embodiments of the disclosure are implemented as follows.

An embodiment of the disclosure provides a text generation method including operations as follows. Multi-scale scaling processing is performed on a first image to obtain a plurality of second images, and feature extraction processing is performed on each of the second images to obtain features of each of the second images. Channel shuffle processing is performed on channels of first features to obtain a first processing result of the first features, and channel shuffle processing is performed on channels of a second feature to obtain a second processing result of the second feature. Herein, the first feature is a feature of any one of the second images, and the second feature is a feature different from the first feature among the features of the second image. Fusion processing is performed on the first processing result and the second processing result to obtain a third feature, and the third feature is mapped to a same feature space as the first feature to obtain fourth features corresponding to the first features. Fusion processing is performed on the fourth features corresponding to the first features based on weights of the first features to obtain a fifth feature. A second text is generated based on the fifth feature and a first text corresponding to the first image.

An Embodiment of the disclosure provides an electronic device including a memory and a processor. The memory is configured to store computer-executable instructions or computer programs. The processor is configured to execute the computer-executable instructions or computer programs stored in the memory to perform operations of: performing multi-scale scaling processing on a first image to obtain a plurality of second images, and performing feature extraction processing on each of the second images to obtain features of each of the second images; performing channel shuffle processing on channels of first features to obtain a first processing result of the first features, and performing channel shuffle processing on channels of a second feature to obtain a second processing result of the second feature, where the first feature is a feature of any one of the second images, and the second feature is a feature different from the first feature among the features of the second image; performing fusion processing on the first processing result and the second processing result to obtain a third feature, and mapping the third feature to a same feature space as the first feature to obtain fourth features corresponding to the first features; performing fusion processing on the fourth features corresponding to the first features based on weights of the first features to obtain a fifth feature; and generating a second text based on the fifth feature and a first text corresponding to the first image.

An embodiment of the disclosure provides a non-transitory computer-readable storage medium having stored thereon computer-executable instructions or computer programs that, when executed by a processor, cause the processor to perform operations of: performing multi-scale scaling processing on a first image to obtain a plurality of second images, and performing feature extraction processing on each of the second images to obtain features of each of the second images; performing channel shuffle processing on channels of first features to obtain a first processing result of the first features, and performing channel shuffle processing on channels of a second feature to obtain a second processing result of the second feature, where the first feature is a feature of any one of the second images, and the second feature is a feature different from the first feature among the features of the second image; performing fusion processing on the first processing result and the second processing result to obtain a third feature, and mapping the third feature to a same feature space as the first feature to obtain fourth features corresponding to the first features; performing fusion processing on the fourth features corresponding to the first features based on weights of the first features to obtain a fifth feature; and generating a second text based on the fifth feature and a first text corresponding to the first image.

### BRIEF DESCRIPTION OF THE DRAWINGS

FIG. 1 is a schematic structural diagram of a text large model according to an embodiment of the disclosure.

FIG. 2 is a schematic structural diagram of a text generation system 100 according to an embodiment of the disclosure.

FIG. 3 is a schematic structural diagram of an electronic device 500 according to an embodiment of the disclosure.

FIG. 4 is a schematic flowchart of a text generation method according to an embodiment of the disclosure.

FIG. 5 is a schematic flowchart of a text generation method according to an embodiment of the disclosure.

FIG. 6 is a schematic flowchart of a text generation method according to an embodiment of the disclosure.

FIG. 7 is a diagram showing a model framework of a text generation method according to an embodiment of the disclosure.

FIG. 8 is an architecture diagram of a feature fusion module according to an embodiment of the disclosure.

FIG. 9 is an architecture diagram of a mutual information module according to an embodiment of the disclosure.

### DETAILED DESCRIPTION

To make the objectives, technical solutions, and advantages of the disclosure clearer, the following describes the disclosure in further detail with reference to the accompanying drawings. The described embodiments are not to be considered as a limitation to the disclosure. All other embodiments obtained by a person of ordinary skill in the art without creative efforts shall fall within the protection scope of the disclosure.

In the following description, the term “some embodiments” describes subsets of all possible embodiments, but it may be understood that “some embodiments” may be the same subset or different subsets of all the possible embodiments, and can be combined with each other without conflict.

It can be understood that in the embodiments of the disclosure, related data such as user information is involved, and when the embodiments of the disclosure are applied to specific products or technologies, the user's permission or consent is required to collect these data, and the collection, use and processing of related data need to comply with relevant laws, regulations and standards.

In the embodiments of the disclosure, the term “module” or “unit” refers to a computer program or a part of a computer program having a predetermined function and working together with other relevant parts to achieve a predetermined object, and may be achieved in whole or in part by using software, hardware (such as processing circuitry or memory), or a combination thereof. Likewise, a processor (or processors or memories) may be used to implement one or more modules or units. Furthermore, each module or unit may be part of an overall module or unit that contains functions of the module or unit.

In the following description, the terms “first” and “second” are merely intended to distinguish between similar objects rather than describe a specific order of objects. It can be understood that the “first” and “second” are interchangeable in order in proper circumstances, so that embodiments of the disclosure described herein can be implemented in an order other than the order illustrated or described herein.

Unless otherwise defined, meanings of all technical and scientific terms used in the embodiments of the disclosure are the same as those usually understood by a person skilled in the technical field to which the embodiments of the disclosure belong. Terms used in the embodiments of the disclosure are merely intended to describe objectives of the embodiments of the disclosure, and are not intended to limit the disclosure.

Before embodiments of the disclosure are further described in detail, terms in embodiments of the disclosure are described, and the following explanations are applicable to the terms in embodiments of the disclosure.
1) A large document model is an advanced artificial intelligence model that integrates Natural Language Processing (NLP) and Computer Vision (CV) technologies. The model is specially designed to understand and process information in documents, regardless of whether it is a scanned paper document or an electronic document. The large document model can comprehensively analyze the text, images, tables and layouts in the document, thereby realizing the understanding, extraction and generation of document content.
2) A Vision Transformer (ViT) is a deep learning model that applies the Transformer architecture to computer vision tasks, and captures global information by transforming images into sequence data and utilizing self-attention mechanisms.
3) A Multi-Layer Perceptron (MLP) is an artificial neural network-based supervised learning model for solving complex nonlinear problems, which can be widely used in classification and regression tasks. The MLP is a feedforward artificial neural network, which is composed of multiple neurons (or neural nodes). These neurons are arranged in a hierarchical structure, including an input layer, hidden layer(s) and an output layer. The neurons between layers are connected by weights, and information propagates forwards from the input layer to the output layer in turn without feedback connection.

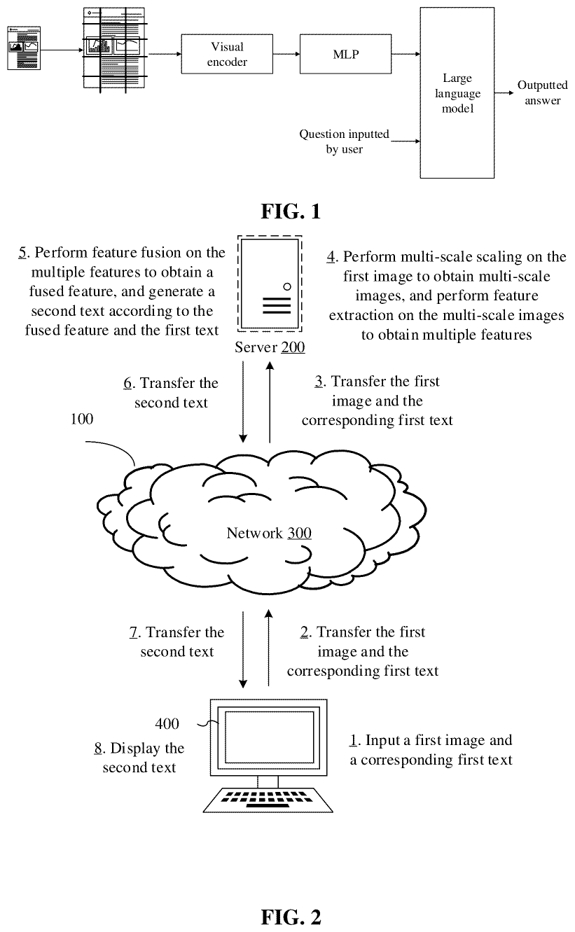

In the related art, referring to FIG. 1, it is a schematic structural diagram of a large document model according to an embodiment of the disclosure. As shown in FIG. 1, a picture is directly passed through a visual encoding module of a ViT, and then a processing result of the visual encoding module is connected with a large language model through an MLP, thereby obtaining the large document model. However, directly inputting the image into the ViT model can only get information of the image with a current scale, and only inputting the image with the single scale, the model may miss some information, resulting in low accuracy of the generated answer.

Based on this, embodiments of the disclosure provide a text generation method and apparatus, an electronic device, a computer-readable storage medium, and a computer program product, which can effectively improve the accuracy of picture content analysis and text content. The electronic device according to the embodiment of the disclosure may be implemented as a server, or may be implemented by a server and a terminal in cooperation. Hereinafter, the text generation method provided by the embodiment of the disclosure is described by taking the server cooperating with the terminal cooperate as an example.

For example, referring to FIG. 2, it is a schematic architecture diagram of a text generation system 100 provided by an embodiment of the disclosure. In order to support a text generation application, as shown in FIG. 2, the text generation system 100 includes a server 200, a network 300, and a terminal 400; and the terminal 400 is connected to the server 200 through the network 300, where the network 300 may be a local area network or a wide area network, or a combination of both.

In some embodiments, a user inputs a first image and a first text corresponding to the first image through the terminal 400, and transmits the first image and the first text corresponding to the first image to the server 200 through the network 300. Subsequently, the server 200 performs multi-scale scaling processing on the first image to obtain a plurality of second images, and performs feature extraction processing on each second image to obtain features of each second image; then the server 200 generates a second text according to the characteristics of each second image and the first text corresponding to the first image. Finally, the server 200 may transmit the generated second text to the terminal 400 through the network 300, and display the second text on the terminal 400.

The text generation method according to the embodiments of the disclosure can be applied to various scenarios that require text information generation, for example, it can be applied to in the field of education, medical health, daily consumption, industrial manufacturing, or public services.
1) In the field of education, taking interactive teaching assistance as an example, students upload pictures of animals and plants to ask questions (such as “what are the names of plants in the pictures?”), the system combines visual and text analysis to generate answers, which can enhance the interactivity of teaching; and the system can also recognize experimental equipment through images and answer operational questions (such as “how to connect the circuit?”). Taking personalized learning as an example, according to the handwritten images uploaded by students to solve problems, the system can identify wrong steps and provide targeted analysis. It can also generate exercise lesson plans combining pictures and texts to adapt to students' different learning stages.
2) In medical health, taking medical image analysis as an example, the types, numbers and distribution of cells are automatically identified in Cell microscopy examination, and diagnostic reports can also be generated based on CT/MRI images to assist doctors in judging the location and nature of lesions; and taking health monitoring as an example, skin lesion images can be identified and preliminary diagnostic suggestions can be provided (such as rash classification), and infant behavioral images (such as crying posture) can also be analyzed to infer needs (such as hunger, discomfort, etc.).
3) In daily consumption, taking smart wearing and shopping as an example, one can upload clothing pictures to generate matching suggestions (such as “what clothes are these earrings suitable for?”); And the system can also identify product attributes and answer usage questions based on questions and answers related to product images. Taking home safety as an example, detection images in homes can be used to identify abnormal behaviors (such as elderly people falling, etc.), and alarms can be triggered. One can also take pictures showing equipment status to obtain equipment maintenance guidance.
4) In industrial manufacturing, taking production process optimization as an example, the system can identify production line equipment images, automatically generate fault diagnosis reports and maintenance plans, and can also detect defects (such as part size deviations, etc.) through product images during quality inspection. Taking autonomous driving as an example, the system can perform real-time analysis of road images and provide complex road conditions (such as “types of obstacles ahead”, etc.), and it can also predict pedestrian or vehicle behaviors and improve the safety of decision-making.
5) In public services, taking government affairs and laws as an example, the system can be used to verify certificate images (such as authenticity identification of ID cards) and answer the handling process, and can also perform content extraction on legal document images and review their compliance. Taking scientific research data analysis as an example, the system can analyze charts in academic papers (such as “Experimental Data Trend Description”, etc.), and can also analyze astronomical or geological images (such as star classification, rock composition identification, etc.).

Exemplarily, the server 200 in FIG. 2 may be an independent physical server, a server cluster or a distributed system including a plurality of physical servers, or a cloud server that provides a basic cloud computing service such as a cloud service, a cloud database, cloud computing, a cloud function, cloud storage, a network service, cloud communication, a middleware service, a domain name service, a security service, a content delivery network (CDN) and a big data and artificial intelligence platform. The terminal 400 may be a smartphone, a tablet computer, a laptop, a desktop computer, a smart speaker, a smart watch, a vehicle terminal, or the like, but is not limited thereto. The terminal 400 and the server 200 may be directly or indirectly connected by wired or wireless communication, which is not limited in the embodiments of the present disclosure.

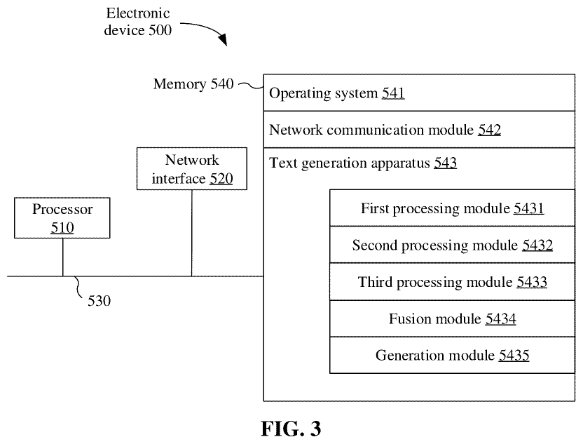

The structure of the electronic device according to embodiments of the disclosure will be described below. Referring to FIG. 3, it is a schematic structural diagram of a server 500 according to an embodiment of the disclosure, and the terminal 500 shown in FIG. 3 includes at least one processor 510, a memory 540, and at least one network interface 520. The various components in the electronic device 500 are coupled together by a bus system 530. It may be understood that, the bus system 530 is configured to implement connection and communication between the components. In addition to a data bus, the bus system 530 includes a power bus, a control bus, and a status signal bus. However, for clarity of description, various buses are marked as the bus system 530 in FIG. 3.

The processor 510 may be an integrated circuit chip with a signal processing capability, for example, a general-purpose processor, a digital signal processor (DSP), another programmable logic device, a discrete gate or transistor logic device, or a discrete hardware component. The general-purpose processor may be a microprocessor, any conventional processor, or the like.

The memory 540 may be a removable memory, a non-removable memory, or a combination thereof. Exemplary hardware devices include a solid-state memory, a hard disk drive, an optical disc drive, and the like. The memory 540 may include one or more storage devices physically located away from the processor 510.

The memory 540 includes a volatile memory or a non-volatile memory, or may include both a volatile memory and a non-volatile memory. The non-volatile memory may be a read-only memory (ROM). The volatile memory may be a random access memory (RAM). The memory 540 described in this embodiment of the disclosure is intended to include any suitable type of memory.

In some embodiments, the memory 540 is capable of storing data to support various operations. Examples of the data include a program, a module, and a data structure or a subset or superset thereof. Examples are described below:
an operating system 541, including system programs for processing various basic system services and performing hardware-related tasks, for example, a framework layer, a core library layer, and a driver layer for implementing various basic services and processing hardware-based tasks;
a network communication module 542, configured to reach another electronic device through one or more (wired or wireless) network interfaces 620, exemplary network interfaces 620 including Bluetooth, wireless fidelity (Wi-Fi), universal serial bus (USB), and the like;

In some embodiments, the apparatus provided in embodiments of the disclosure may be implemented by using software. FIG. 3 shows a text generation device 543 stored in the memory 540. The text generation device 543 may be software in the form of a program or a plug-in, and includes the following software modules: a first processing module 5431, a second processing module 5432, a third processing module 5433, a fusion module 5434 and a generation module 5435. These modules are logical modules, and therefore may be flexibly combined or further split based on an implemented function.

Hereinafter, the text generation method provided by the embodiments of the disclosure will be specifically described in conjunction with an exemplary application and implementation of the server provided by the embodiment of the disclosure.

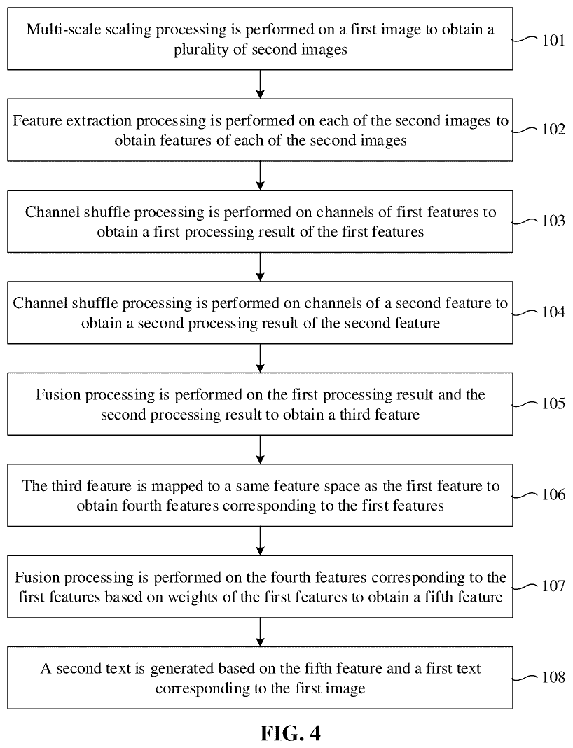

Referring to FIG. 4, it is a schematic flowchart of a text generation method according to an embodiment of the disclosure, and the steps shown in FIG. 4 will be described below.

In step 101, multi-scale scaling processing is performed on a first image to obtain a plurality of second images.

It is to be noted that the multi-scale scaling processing on an image may be performed by processing the image using a dedicated image processing software (for example, Photoshop), or may be performed by using a related programming codes (for example, Python+OpenCV), or may be implemented by a customized scaling algorithm (for example, nearest neighbor interpolation method). No specific limitations are made herein.

As an example, assuming that the resolution of the first image is 1024*768, and the scaling ratios are 1.0, 0.5, and 0.25, respectively, and the scaling processing is performed on the first image according to the scaling ratios, respectively, so that the resolution of the second image having the scaling ratio of 1.0 is 1024*768, the resolution of the second image having the scaling ratio of 0.5 is 512*384, and the resolution of the second image having the scaling ratio of 0.25 is 256*192.

In operation 102, feature extraction processing is performed on each of the second images to obtain features of each of the second images.

It is to be noted that the feature extraction processing may be performed on each second image using a single network to obtain the features of each second image, or the feature extraction processing may be performed for various second image using different networks to obtain the features of the second images. No specific limitations are made herein.

As an example, taking a single network as an example, assuming that the resolutions of the second images generated by multi-scale scaling are 256*256, 512*512, and 1024*1024, respectively, and the second images of different sizes are directly inputted into the same network (such as ResNet-50) for feature extraction, thereby obtaining the features of each second image. Taking multiple networks as an example, assuming that the resolutions of the second images generated by multi-scale scaling are 256*256, 512*512, and 1024*1024, respectively, feature extraction can be performed on the second image with a resolution of 256*256 using a lightweight network (e.g., MobileNetV3), feature extraction can be performed on the second image with a resolution of 512*512 using a medium depth network (e.g., ResNet-50), and feature extraction can be performed on the second image with a resolution of 1024*1024 using a deep network (e.g., ResNet-152).

In some embodiments, the step 102 can be implemented by: for each of the second images, invoking a first neural network corresponding to a size of the second image to perform feature extraction processing on the second image to obtain the features of the second image, where a spatial complexity of the first neural network is negatively correlated with the size of the second image. In this way, by designing the spatial complexity of the neural network to be negatively correlated with the size of the second image, it is possible to achieve the balance of computing resources, feature quality and hardware adaptability, and the method can be effectively applied to scenarios where multi-scale data are mixed and resources are limited, thereby providing an efficient and flexible feature extraction method for image processing tasks.

It is to be noted that the spatial complexity of the neural network is used to represent a number of parameters of the model, that is, the more parameters of the model, the greater the amount of data required to train the model, and the greater the spatial complexity of the neural network corresponding to the model.

As an example, assuming that there are two second images of different sizes, namely a small-sized image (with resolution of 256*256) and a large-sized image (with a resolution of 512*512). It can be determined, according to the size, that the small-sized image corresponds to a neural network with high spatial complexity (such as ResNet-152), and the large-sized image corresponds to a neural network with low spatial complexity (such as MobileNetV3), and feature extraction is performed on images of different sizes through their corresponding neural networks to obtain the features of the second images.

In step 103, channel shuffle processing is performed on channels of first features to obtain a first processing result of the first features.

Here, the first feature is a feature of any one of the second images.

It is to be noted that channel shuffle processing is a key operation in the ShuffleNet network architecture, which aims to optimize network computing efficiency and feature fusion. The ShuffleNet reduces the computational load of 1*1 convolution and improves the efficiency and performance of the model through group convolution and channel shuffle operations. The main purpose of channel shuffle is to make the features between different convolution groups alternately serve as input features of subsequent networks, so as to enhance the representability of the whole network, reduce the computational complexity of the model, and ensure the quality of the network. Through channel shuffle processing, different groups of features can be fused with each other in subsequent convolution operations to improve the diversity and expression ability of features.

Herein, the specific implementation process of the channel shuffle process includes: dimensions of the input channels are rearranged, rearranged channels are divided into a plurality of groups; and the features of each group are transposed, and the transposed features are flattened to form a new channel sequence.

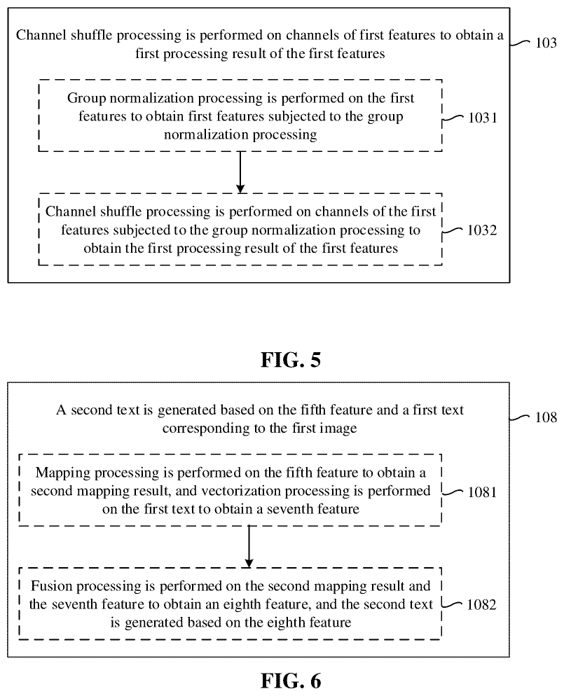

In some embodiments, referring to FIG. 5, it is a schematic flowchart of the text generation method provided by the embodiment of the disclosure. As shown in FIG. 5, step 103 shown in FIG. 4 can be implemented by steps 1031 to 1032 shown in FIG. 5, and description will be made below in conjunction with the steps shown in FIG. 5.

In step 1031, group normalization processing is performed on the first features to obtain first features subjected to the group normalization processing.

It should be noted that the group normalization processing is a normalization technique in machine learning, which refers to constraining parameters during the model training process to prevent overfitting, and at the same time, learning group structure information between features.

As an example, assuming that the number of channels of the first feature is C, group normalization processing is performed on the first feature, that is, the number C of channels are divided into G groups, then each group contains C/G channels; and for each channel group, the average value μ and variance σ² of all position feature values in the group are calculated, and normalization processing is performed on each feature value in the group to obtain the normalized feature value

$$\frac{X - μ}{σ} ,$$

where X is the feature value, and then channel-level scaling factors γ and offsets β are introduced to perform linear transformation on the normalized feature values

$$\frac{X - μ}{σ}$$

to obtain feature values

$$\frac{X - μ}{σ} \cdot γ + β$$

subjected to the linear transformation, thereby completing the group normalization processing. All of the feature values subjected to the linear transformation are arranged according to the corresponding positions to obtain the first feature subjected to the group normalization processing, and the number of channels of the first feature subjected to the group normalization processing is still C.

In step 1032, channel shuffle processing is performed on channels of the first features subjected to the group normalization processing to obtain the first processing result of the first features.

Following the above example, channel shuffle processing is performed on the channels of the first feature subjected to the group normalization processing, that is, the number of channels of the first feature subjected to the group normalization processing is re-divided into K groups, the channel dimension C of the first feature subjected to the group normalization processing is changed to [K, C/K], the first feature with the dimension of [K, C/K] is transposed to obtain a transposed result with the dimension of [C/K, K], and the transposed result is flattened again to C channels, so that the channel shuffle processing is completed to obtain the first feature subjected to the channel shuffle processing, i.e., the first processing result of the first features.

In this way, by using group normalization processing, the feature distribution can be standardized, the internal covariate shift can be reduced, and the diversity of feature expression can be effectively enhanced by reshuffling the order of channels and breaking the information isolation between channels.

In step 104, channel shuffle processing is performed on channels of a second feature to obtain a second processing result of the second feature.

Herein, the second feature is a feature different from the first feature among the features of the second image.

In some embodiments, the above step 104 can be implemented by: performing group normalization processing on the second feature to obtain the second feature subjected to the group normalization processing, and performing channel shuffle processing on channels of the second feature subjected to the group normalization processing to obtain a second processing result of the second feature. In this way, by using group normalization processing, the feature distribution can be standardized, the internal covariate shift can be reduced, and the diversity of feature expression can be effectively enhanced by reshuffling the order of channels and breaking the information isolation between channels.

It should be noted that the implementation of performing group normalization processing and channel shuffle processing on the second feature in the above step is similar to the implementation of the above steps 1031 and 1032, and for details, reference can be made to the implementation of the above steps 1031 and 1032, which will not be repeated herein.

In some embodiments, prior to performing step 104, the following processing may be further performed: performing sorting processing on features of the plurality of second images based on sizes of the plurality of second images to obtain a feature sequence; if the first feature is located at a start position of the feature sequence, taking, as the second features, a feature adjacent to the first feature in the feature sequence and a feature located at an end position of the feature sequence; if the first feature is located at the end position of the feature sequence, taking, as the second features, a feature adjacent to the first feature in the feature sequence and a feature located at the start position of the feature sequence; and if the first feature is not at the end position of the feature sequence and is not at the start position of the feature sequence, taking, as the second features, features adjacent to the first feature in the feature sequence. In this way, the feature sequence is established based on the sizes of the plurality of second images, and efficient operation can be performed based on the feature sequence, thereby improving the subsequent processing efficiency; By reasonably selecting the second feature, rich and representative feature information is provided for subsequent processing tasks, thus improving the accuracy and reliability of subsequent processing.

As an example, for example, if the size of the second image corresponding to the feature E1 of the second image is 1024*1024, the size of the second image corresponding to the feature E2 of the second image is 512*512, and the size of the second image corresponding to the feature E3 of the second image is 128*128, then the feature sequence obtained by sorting the features of the second images according to the sizes of the second images is E1, E2, and E3. Assuming that the first feature is at the start position of the feature sequence, such as E1, the second features are E2 (the feature adjacent to the first feature) and E3 (the feature at the end position of the feature sequence). Assuming that the first feature is at the end position of the feature sequence, such as E3, the second features are E1 (the feature at the start position of the feature sequence) and E2 (the feature adjacent to the first feature). Assuming that the first feature is not at the end position of the feature sequence and is not at the start position of the feature sequence, such as E2, the second features are E1 (the feature adjacent to the first feature) and E3 (the feature adjacent to the first feature).

In some embodiments, prior to performing step 104, the following processing may be further performed: performing sorting processing on features of the plurality of second images based on sizes of the plurality of second images to obtain a feature sequence; if the first feature is located at a start position of the feature sequence, selecting, as the second features, any two features from among features other than a feature adjacent to the first feature and a feature located at the end position of the feature sequence; if the first feature is located at the end position of the feature sequence, selecting, as the second features, any two features from among features other than a feature adjacent to the first feature and a feature located at the start position of the feature sequence; and if the first feature is not at the end position of the feature sequence and is not at the start position of the feature sequence, selecting, as the second features, any two features from among features other than features adjacent to the first feature. In this way, by introducing information of non-adjacent features, global context information can be constructed, and it is possible to avoid omission of important information due to local window restrictions, thus breaking through local restrictions and capturing long-distance dependencies between features.

As an example, assuming that the feature sequence is {E1, E2, E3, E4, E5}, if the first feature is E1, the second features may be E3 and E4; if the first feature is E5, the second features may be E2 and E3; and if the first feature is E2, the second features may be E4 and E5.

In step 105, fusion processing is performed on the first processing result and the second processing result to obtain a third feature.

It is to be noted that the fusion processing on the first processing result and the second processing result may be performed by directly splicing the two processing results, or may be performed by a method of adding feature values. No specific limitations are made herein.

As an example, assuming that the feature size of the first processing result is 4096*768 and the feature size of the second processing result is 4096*768, taking splicing features as an example, the two features are spliced to obtain a third feature having a feature size of 9192*768.

In some embodiments, the step 105 may be implemented by: if a plurality of the second features exist, performing fusion processing on the first processing result and each second processing result respectively to obtain the third feature corresponding to each of the second features. In this way, by fusing different processing results, different feature information can be summarized, so that each third feature contains more comprehensive and rich information; and by fusing different second features separately, the diversity information of features can be captured more comprehensively, so as to make full use of the diversity of features.

As an example, assuming that the feature sequence is {E1, E2, E3, E4, E5}, the second features corresponding to the first feature E1 are E2 and E5, the first processing result of the first feature E1 is E1_1, the second processing result of the second feature E2 is E2_1, and the second processing result of the second feature E5 is E5_1, then the first processing result E1_1 and the second processing result E2_1 are fused to obtain a third feature E1_new1 of the second feature, the first processing result E1_1 and the second processing result E5_1 are fused to obtain a third feature E1_new2 of the second feature. Similarly, a third feature in which each of the first features corresponds to the second feature can be obtained.

In step 106, the third feature is mapped to a same feature space as the first feature to obtain fourth features corresponding to the first features.

In some embodiments, the step 106 can be implemented by: performing mapping processing on the third feature to obtain a first mapping result; performing dimension repair on the first mapping result to obtain a dimension repair result; performing channel shuffle processing on the dimension repair result to obtain a mapping result subjected to the channel shuffle processing; performing group normalization processing on the mapping result subjected to the channel shuffle processing to obtain the fourth features corresponding to the first features. In this way, through mapping processing, features are mapped to a new feature space through a certain function or transformation, it is possible to increase the nonlinear expression ability of features, thereby capturing more complex feature relationships and patterns. The mapped features are transformed back to the original space through dimension repair processing, which helps to transform complex feature relationships into easier-to-explain association results that are convenient for subsequent processing and analysis. Through grouping and transposing operations, partial randomness of the first channel shuffle is compensated, and cross-channel correlation is restored, so that the channel distribution is more in line with the grouping requirements of subsequent group normalization. Through group normalization, the distribution offset caused by the channel shuffle and intermediate operations is eliminated, and then the scale consistency of features is restored.

As an example, assuming that after obtaining a third feature with a size of 9192*768, the third feature is flattened, and the features of all spatial position are sequentially arranged by remodeling, so that a feature with a feature size of 7059456*1 can be obtained. Then, the feature with a feature size of 7059456*1 is input into the MLP for mapping processing, and two features with a feature size of 3529728*1 can be obtained, that is, the first mapping results can be obtained. Dimension repair is performed on the first mapping result according to the dimension size of the first feature to obtain two 4096*768 features, that is, dimension repair result. Assuming that the number of channels of the feature corresponding to the dimension repair result is C, the number C of channels are divided into M groups, the number of channels of the feature corresponding to the dimension repair result is changed from C to [C, C/M], the feature with [C, C/M] is transposed to obtain the transposed result of [C/M, C], and the transposed result is flattened to restore the feature to the original channel dimension C, thereby obtaining the feature having its channel sequence restored, that is, obtaining the dimension flattening result. Then, the number of channels of the feature having its channel sequence restored is re-divided into N groups, then each group contains C/N channels, and for each channel group, the average value μ and the variance σ² of feature values of all positions in the group are calculated, and normalization processing is performed each feature value in the group to obtain the normalized feature value X−μ/σ, where X is the feature value, then a learnable scaling factor γ_{recover} and offsets β_{recover} are used to scale and offset the features to minimize the damage to the original features, so as to obtain the features after dimension restoration, that is, the fourth features corresponding to the first features.

In some embodiments, if a plurality of the second features exist, the step 6 may be implemented by: mapping the third feature corresponding to each of the second features to a same feature space as the first feature to obtain the fourth feature of each second feature corresponding to the first feature. Thus, by mapping the third feature to the same feature space as the first feature, it is possible to better adapt subsequent task processing.

It should be noted that the implementation of performing mapping processing on the third feature of each second feature is similar to the implementation of the above step 106, and for details, reference can be made to the implementation of the above step 106, which will not be repeated herein.

In step 107, fusion processing is performed on the fourth features corresponding to the first features based on weights of the first features to obtain a fifth feature.

As an example, assuming that the weight of the first feature E1 is w1, the weight of the first feature E2 is w2, the fourth feature corresponding to the first feature E1 is E1_new, and the fourth feature corresponding to the first feature E2 is E2_new, then weighted fusion processing is performed on the fourth features corresponding to the first features, which can obtain the fifth feature E that is w1*E1 new+w2*E2_new.

In some embodiments, before performing the step 107, the following steps can further be performed: performing fusion processing on the first features to obtain a sixth feature; performing mapping processing on the sixth feature to obtain a first mapping result; and performing normalization processing on the first mapping result to obtain a weight corresponding to each of the first features. In this way, through mapping processing, the differences between features can be enhanced, so that similar features are more closely clustered together, while different features are more dispersed, which helps to enhance the expressiveness of features. The normalization process ensures that each feature has the same importance to the weight of the model, and avoids the disproportionate impact of some features on the model results since these features have a large numerical range.

It is to be noted that the fusion process can be implemented by operating basic features, such as addition fusion, multiplication fusion, splicing fusion, weighted fusion, and the like. The fusion can also be driven by advanced mechanisms, such as attention mechanism fusion, pyramid pooling fusion, de-convolution fusion, etc. The fusion can also be implemented through mathematical transformation and interaction, such as linear combination fusion, nonlinear combination fusion, feature interaction fusion, etc. The fusion can also be implemented through hierarchical strategy fusion, such as early fusion, late fusion, intermediate fusion, etc. The fusion can also be implemented by engineering optimization methods, such as aggregate function fusion, embedding fusion, etc. No specific limitations are made herein.

As an example, assume that there are five first features E1, E2, E3, E4, and E5, respectively, and the size of each feature is 4096*768, then the five first features are spliced and fused to obtain a sixth feature with a size of 20480*768, and dimension flattening processing is performed on the sixth feature to obtain a dimension flattening result of the sixth feature, that is, a feature with a size of 15728640*1. Then, mapping processing is performed on the dimension flattening result of the sixth feature to obtain a first mapping result, that is, a feature having a size of 5*1. Finally, normalization processing is performed on the first mapping result to obtain probabilities for features with a size of 5*1 that are [0.4, 0.2, 0.15, 0.01, 0.24], that is to say, the weight corresponding to the first feature E1 is 0.4, the weight corresponding to the first feature E2 is 0.2, the weight corresponding to the first feature E3 is 0.15, the weight corresponding to the first feature E4 is 0.01, and the weight corresponding to the first feature E5 is 0.25.

In some embodiments, the step 107 may be implemented by: performing fusion processing on the fourth features corresponding to the first features and the first features to obtain ninth features corresponding to the first features; and performing weighting processing on the ninth features corresponding to the first features based on weights of the first features to obtain the fifth feature. In this way, the fourth feature corresponding to the first feature is fused with the first feature, and the feature information obtained from different sources or different processing methods can be integrated together, and the features of the image can be described more comprehensively and meticulously, thereby enhancing the expression ability of the features.

As an example, assuming that the weight of the first feature E1 is w1, the weight of the first feature E2 is w2, the fourth feature corresponding to the first feature E1 is E1_new, and the fourth feature corresponding to the first feature E2 is E2_new, then by performing fusion processing on the first feature and the fourth feature corresponding to the first feature, a ninth feature E1 inter of the first feature E1 is E1+E1_new, and a ninth feature E2 inter of the first feature E2 is E2+E2_new, and weighted fusion processing is performed on the ninth features corresponding to the first features according to the weights of the first features, to obtain a fifth feature E that is w1*E1 inter+w2*E2 inter.

In some embodiments, if a plurality of the second features exist, the step 107 may be implemented by: performing fusion processing on the fourth feature of all second features corresponding to the first features and the first features to obtain ninth features corresponding to the first features; and performing weighting processing on the ninth features corresponding to the first features based on weights of the first features to obtain the fifth feature. In this way, the fourth feature of each second feature corresponding to the first feature is fused with the first feature, and the feature information obtained from different sources or different processing methods can be integrated together, and the features of the image can be described more comprehensively and meticulously, thereby enhancing the expression ability of the features.

As an example, assuming that the weight of the first feature E1 is w1, the weight of the first feature E2 is w2, the fourth feature of the second feature E3 corresponding to the first feature E1 is E1_new1, the fourth feature of the second feature E4 corresponding to the first feature E1 is E1 new2, the fourth feature of the second feature E5 corresponding to the first feature E2_new1, and the fourth feature of the second feature E6 corresponding to the first feature E2_new2, then the fourth feature of each second feature corresponding to the first feature E1 is fused with the first feature (taking the addition of feature values as an example), and the ninth feature E1_inter corresponding to the first feature E1 can be obtained as E1+E1 new1+E1 new2. Likewise, the ninth feature E2_inter corresponding to the first feature E2 is E2+E2_new1+E2_new2, and finally, weighted fusion processing is performed on the ninth features corresponding to the first features according to the weight of the first features to obtain the fifth feature E that is w1*E1 inter+w2*E2 inter.

In step 108, a second text is generated based on the fifth feature and a first text corresponding to the first image.

In some embodiments, referring to FIG. 6, it is a schematic flowchart of the text generation method provided by the embodiment of the disclosure. As shown in FIG. 6, step 108 shown in FIG. 4 can be implemented by steps 1081 to 1082 shown in FIG. 6, and description will be made below in conjunction with the steps shown in FIG. 6.

In step 1081, mapping processing is performed on the fifth feature to obtain a second mapping result, and vectorization processing is performed on the first text to obtain a seventh feature.

As an example, assuming that the first image is a picture containing a brown fox, and the fifth feature obtained by processing is f₁, then the second mapping result obtained by performing mapping processing on the fifth feature f₁ is f₂; and the first text is “What color is the animal in this picture?”, then the seventh feature obtained by vectorizing the first text is f₃.

In step 1082, fusion processing is performed on the second mapping result and the seventh feature to obtain an eighth feature, and the second text is generated based on the eighth feature.

Following the above example, fusion processing is performed on the second mapping result f₂ and the seventh feature f₃ to obtain the eighth featuref₄, and finally an answer prediction is performed according to the eighth featuref₄ to generate a second text “The animal in this picture is brown”.

In this way, by combining the features from different sources, multi-source information is fully utilized, which provides strong support for generating accurate and relevant text content.

In some embodiments, taking an image generation scene as an example, it is assumed that the first image is an abstract painting with simple geometric graphics (circles, triangles, and squares), and the fifth feature g₁ is obtained by processing the first image, mapping processing is performed on the fifth feature g₁ to obtain a second mapping result g₂; the first text is “generate a picture containing these graphics and more brightly colored”, vectorization processing is performed on the first text to convert the semantic information in the first text into a vector form, and the seventh feature is obtained as g₃; fusion processing is performed on the second mapping result g₂ and the seventh feature g₃ by combining image features with semantic features of text description to obtain an eighth feature g₄; based on the eighth feature g₄, the image generation model will generate a new image that conforms to the text description based on the fused features, and the generated second text can be a simple description of the generated image, such as “an abstract painting containing brightly colored circles, triangles and squares”.

In some embodiments, taking a music recommendation scene as an example, it is assumed that the first image is a photo of a singer performing on a stage, and the fifth feature h₁ is obtained by performing feature processing on the first image. Mapping processing is performed on the fifth feature h₁ to obtain a second mapping result h₂, the first text is “recommend music similar to this singer's style”, vectorization processing is performed on the first text to convert the user's recommendation requirements into a vector to obtain the seventh feature h₃; fusion processing is performed on the second mapping result h₂ and the seventh feature h₃ by combining the style feature of the singer in the image and the recommendation requirement of the user to obtain the eighth feature h₄. Based on the eighth feature h₄, the music recommendation system will recommend suitable music for users according to the fused feature, and the generated second text may be a recommended music list, for example, “Recommend song 1 of singer A, song 2 of singer B, etc.”.

In some embodiments, taking a commodity recommendation scene as an example, it is assumed that the first image is a picture of a fashionable sports shoe, and the fifth feature k₁ is obtained by processing the first image, mapping processing is performed on the fifth feature k₁ to obtain a second mapping result k₂, and the first text is “recommend sports shoes of similar styles”, then vectorization processing is performed on the first text to convert the user's product recommendation demand into a vector to obtain the seventh feature k₃. Subsequently, fusion processing is performed on the second mapping result k₂ and the seventh feature k₃ by combining the features of the sports shoe with the recommendation requirements of the user to obtain the eighth feature k₄; and based on the eighth feature k₄, the product recommendation system will recommend sports shoes of similar styles to users according to the fused feature, and the generated second text may be a recommended product list, such as “recommend sports shoes 1 of brand X, sports shoes 2 of brand Y, etc.”.

In some embodiments, the above-described text generation method is implemented by invoking the first model to, before step 101, further perform following operations of: perform multi-scale scaling processing on a third image to obtain a plurality of fourth images; and perform, by the first model, feature extraction processing on each of the fourth images to obtain features of each of the fourth images, perform channel shuffle processing on channels of tenth features to obtain a third processing result of the tenth features, and perform channel shuffle processing on channels of an eleventh feature to obtain a fourth processing result of the eleventh feature, where the tenth feature is a feature of any one of the fourth images, and the eleventh feature is a feature different from the tenth feature among the features of the fourth image; perform fusion processing on the third processing result and the fourth processing result to obtain a twelfth feature, and map the twelfth feature to a same feature space as the tenth feature to obtain thirteenth features corresponding to the tenth features; perform fusion processing on the thirteenth features corresponding to the tenth features based on weights of the tenth features to obtain a fourteenth feature; generate a predicted text based on the fourteenth feature and a third text corresponding to the third image; determine a first loss based on the predicted text and a true text corresponding to the third image; and update parameters of the first model based on the first loss to obtain an updated first model. Thus, through multi-scale feature analysis and fusion, the model can understand the image content more accurately and generate more accurate text, which can effectively improve the text generation ability of the first model; using multi-scale processing and feature fusion helps the model to adapt to different types of images and problems, thus enhancing the generalization ability of the model; through complex multi-scale feature analysis and fusion, and the training of the model based on weight optimization, the accuracy of text content generated by the model can be significantly improved.

As an example, assuming that the third image is an image including a plurality of objects, firstly, multi-scale scaling processing is performed on the third image to obtain fourth images of three different scales, where the scaling ratio of the fourth image P1 is 1, the scaling ratio of the fourth image P2 is 0.5, and the scaling ratio of the fourth image P3 is 0.25. Then, the features of P1, P2 and P3 are extracted by the first model to obtain corresponding features E1, E2 and E3. Next, when the tenth feature is E1 and the eleventh features are E2 and E3, channel shuffle processing is performed on the tenth feature E1 to obtain a third processing result of E1_new1, and channel shuffle processing is performed on the eleventh features E2 and E3 respectively to obtain the fourth processing results of E2_new1 and E3_new1. Likewise, one can obtain the corresponding third processing result E2_new2 and the fourth processing result E1_new2 and E3_new2 when the tenth feature is E2, and the corresponding third processing result E3_new3 and the fourth processing result E1_new3 and E2_new3 when the tenth feature is E3. Then, fusion processing is performed on the third processing result E1_new1 and the fourth processing results E2_new1 and E3_new1 to obtain the twelfth feature E1 inter, and the twelfth features E2_inter and E3_inter are obtained in the same manner. Then, the twelfth feature E1_inter is mapped to the same feature space as the tenth feature to obtain the thirteenth feature E1_lim, and the thirteenth features E2_lim and E3_lim are obtained in the same manner. Next, assuming that the weight of the tenth feature E1 is w1, the weight of E2 is w2, and the weight of E3 is w3, fusion processing is performed on the thirteenth features corresponding to the tenth features based on the weights of the tenth features to obtain the fourteenth feature E that is w1*E1_lim+w2*E2_lim+w3*E3_lim. Then, assuming that the third text corresponding to the third image is “What animals are in this picture?”. A predicted text “there are dogs and cats in this picture” is generated based on the fourteenth feature E and the third text. Assuming that the corresponding real text is “there are dogs and cats in this picture”, the first loss L can be determined by formula (1) according to the predicted text and the real text. Finally, the parameters of the first model are updated using gradient descent or other optimization algorithms according to the first loss L to obtain the updated first model. In this way, by continuously optimizing the model parameters, multi-scale image information can be used to understand the image content more comprehensively, and more accurate and relevant text content can be generated through feature association and weight-based fusion.

L=−Σᵢy_{true,i} log(y_{pred,i}) (1)

Herein, y_{true,i} is the real text corresponding to the i-th image, y_{pred,i} is the prediction probability of each word in the predicted text corresponding to the i-th image.

In practical applications, when the first loss reaches a parameter threshold, the first loss is back-propagated in the first model, and the model parameters of the first model are updated in the process of propagation.

Back propagation is described as follows. The third image and the third text are inputted into the input layer of the neural network model, after passing through the hidden layer, and the images finally reach the output layer and a result is outputted, which is the forward propagation process of the neural network model. Since the output result of the neural network model has an error with respect to the actual result, the error between the result and the actual value is calculated, and the error is back propagated from the output layer to the hidden layer until it is propagated to the input layer, and values of the model parameters are adjusted according to the error during the back propagation process. The above process is iterated continuously until convergence.

Taking the loss function L of the first model according to the embodiment of the disclosure as an example, the server determines the first loss based on the loss function, back-propagates the first loss from the output layer in the first model, and back-propagates the first loss layer by layer; and when the first loss reaches each layer, the gradient (that is, the partial derivative of the loss function to the parameter of each layer) is solved based on the propagated first loss, and the parameter of each layer is updated by a value of a corresponding gradient.

Hereinafter, an exemplary application of the embodiment of the disclosure in an actual application scenario will be described. This exemplary application describes the specific implementation process of the text generation method in the intelligent question answering scenario.

In the related art, a picture is directly passed through a visual encoding module of a ViT, and then a processing result of the visual encoding module is connected with a large language model through an MLP, thereby obtaining the large document model. However, directly inputting the image into the ViT model can only get information of the image with a current scale, and only inputting the image with the single scale, the model may miss some information, resulting in low accuracy of the generated answer.

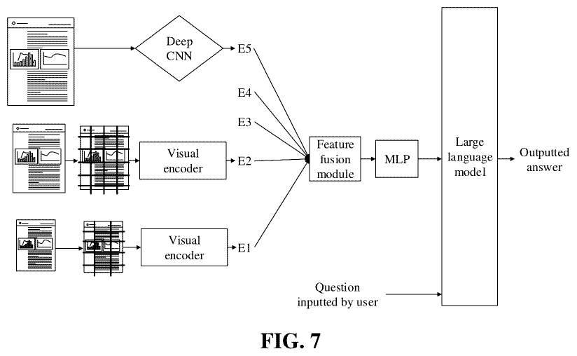

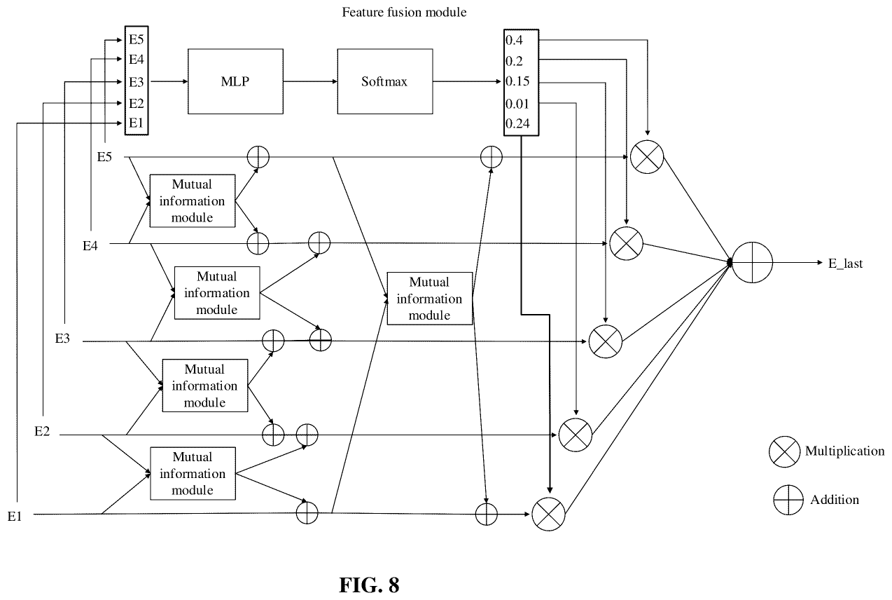

In some embodiments, referring to FIG. 7, it is a model framework diagram of a text generation method according to an embodiment of the disclosure. Hereinafter, the text generation method provided by the disclosure will be specifically described with reference to FIG. 7.

Firstly, the acquired document image is scaled, and the image is scaled while maintaining the aspect ratio, and it is ensured that the total pixels of the image do not exceed 1024*1024, then the image Pmax is obtained. The image Pmax is then scaled at different scales according to different scaling ratios (such as 0.25, 0.38, 0.50, 0.75 and 1.0), and the corresponding scaled images are P1, P2, P3, P4 and P5, respectively. In this way, the model can learn multi-scale image information, allowing the model to provide more accurate features (for (large image, medium image and small image), so that the model can achieve better question answering effects through the feature fusion module.

Then, the image P5 is passed through the RepVGG-A0 backbone network to extract features, followed by an adaptive pooling layer and a fully connected layer, resulting in the corresponding feature matrix E5 (with size of 4096*768). The image P4 is passed through the ResNet18 backbone network to extract features, followed by an adaptive pooling layer and a fully connected layer, resulting in the corresponding feature matrix E4 (with size of 4096*768). The image P3 is passed through the ViT-small backbone network to extract features, resulting in the corresponding feature matrix E3 (with size of 4096*768). The image P2 is passed through the ViT-base backbone network to extract features, resulting in the corresponding feature matrix E2 (with size of 4096*768). The image P1 is passed through the ViT-large backbone network to extract features, resulting in the corresponding feature matrix E1 (with size of 4096*768). Thus, by using different network architectures such as RepVGG, resnet, vit, etc. to process images of different scales, different output information is obtained, so that the model has the ability of model fusion. Here, model fusion is after training multiple models using different backbone networks, fusing the output results of the trained multiple models to achieve higher effects than a single model. In addition, the complexities of RepVGG-A0, resnet18, ViT-small, ViT-base and ViT-large networks increase in turn, and the complexity of P5, P4, P3, P2 and P1 images decreases progressively. By designing the structure of using small network for large images and large network for small images, the feature extraction speed of visual coding module is faster, which makes the model's response faster and reduces its resource consumption.

Then, referring to FIG. 8, it is an architecture diagram of a feature fusion module provided by the embodiment of the disclosure. As shown in FIG. 8, the feature matrices E1, E2, E3, E4 and E5 are sequentially selected in pairs and passed through the mutual information module for mutual information learning, resulting in E1_new1, E1_new2, E2_new1, E2_new2, E3_new1, E3_new2, E4_new1, E4_new2, E5_new1, and E5_new2, respectively. The feature matrices E1_new1 and E1_new2, E2_new1 and E2_new2, E3_new1 and E3_new2, E4_new1 and E4_new2, and E5_new1 and E5_new2 are fused respectively to obtain E1_inter, E2_inter, E3_inter, E4_inter, and E5_inter. Meanwhile, the feature matrices E1, E2, E3, E4, and E5 are combined to form a feature matrix with dimension of 20480*768. This feature matrix is then flattened to obtain a feature matrix with dimension of 15728640*1. The flattened feature matrix is passed through an MLP for mapping, to obtain a feature matrix with dimension of 5*1. This 5*1 feature matrix is then passed through a softmax function for probability prediction, yielding a feature probability matrix with dimension of 5*1. The five feature probabilities are used as the weights for E1_inter, E2_inter, E3_inter, E4_inter, and E5_inter, respectively. Finally, the five feature matrices are weighted and summed with their corresponding weights to obtain the final fused feature matrix E_last. In this way, the feature fusion module fuses a plurality of feature matrices, generates weight probabilities according to the feature matrices, and thereby determines the weight of each feature matrix.

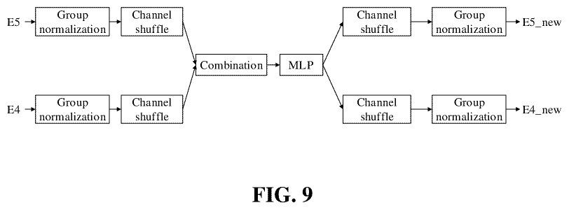

In some embodiments, referring to FIG. 9, it is an architecture diagram of a mutual information module provided by the embodiment of the disclosure. As shown in FIG. 9, taking feature matrices E5 (size 4096*768) and E4 (size 4096*768) as inputs as examples, the upper and lower branches are respectively subjected to group normalization and channel shuffle modules for dimension shuffle to obtain two dimension-shuffled feature matrices, and then the feature matrices generated by the upper and lower branches are spliced to obtain a spliced feature matrix of 9192*768. Then, the spliced feature matrix is flattened to obtain the flattened feature matrix with dimension of 7059456*1, and the flattened feature matrix is input into the MLP module for mapping processing to obtain two feature matrices with dimension of 3529728*1, and the dimensions of the two feature matrices are repaired to obtain two feature matrices with dimension of 4096*768; and the two feature matrices are then passed through the channel shuffle module and the group normalization module, respectively, so that the feature matrices are restored to the same feature space as E5 and E4, to obtain the new feature matrices E5_new and E4_new. In this way, the mutual information module is used to break through the channel barrier between the two feature matrices, and the two feature matrices can learn and influence each other in the channel dimension.

Continuing to refer to FIG. 7, the fused feature E_last is passed through an MLP for feature mapping to obtain the visual feature E_visual. The user's input question is tokenized by a tokenizer to obtain the text feature E_text. These two features are then concatenated (or spliced) and fed into the large language model (Qwen2.5-0.5B) for prediction processing, thereby generating a response that answers the question and is consistent with the image content.

It is to be noted that the network architecture and step flow in the training and reasoning stages of the disclosure are similar, and the parameters of the large language model need to be fixed during the model training process, and the parameters of other modules in the model except the large language model are updated according to the generated first error between the predicted answer and the real answer.

In some embodiments, as shown in FIG. 3, the software module stored in the text generation device 543 in the memory 540 may include a first processing module 5431, a second processing module 5432, a third processing module 5433, a fusion module 5434, and a generation module 5435.

The first processing module 5431 is configured to perform multi-scale scaling processing on a first image to obtain a plurality of second images, and perform feature extraction processing on each of the second images to obtain features of each of the second images; the second processing module 5432 is configured to perform channel shuffle processing on channels of first features to obtain a first processing result of the first features, and perform channel shuffle processing on channels of a second feature to obtain a second processing result of the second feature, where the first feature is a feature of any one of the second images, and the second feature is a feature different from the first feature among the features of the second image; the third processing module 5433 is configured to perform fusion processing on the first processing result and the second processing result to obtain a third feature, and map the third feature to a same feature space as the first feature to obtain fourth features corresponding to the first features; the fusion module 5434 is configured to perform fusion processing on the fourth features corresponding to the first features based on weights of the first features to obtain a fifth feature; and the generation module 5435 is configured to generate a second text based on the fifth feature and a first text corresponding to the first image.

In some embodiments, the first processing module 5431 is further configured to: for each of the second images, invoke a first neural network corresponding to a size of the second image to perform feature extraction processing on the second image to obtain the features of the second image, where a spatial complexity of the first neural network is negatively correlated with the size of the second image.

In some embodiments, the second processing module 5432 is further configured to: perform sorting processing on features of the plurality of second images based on sizes of the plurality of second images to obtain a feature sequence; if the first feature is located at a start position of the feature sequence, take, as the second features, a feature adjacent to the first feature in the feature sequence and a feature located at an end position of the feature sequence; if the first feature is located at the end position of the feature sequence, take, as the second features, a feature adjacent to the first feature in the feature sequence and a feature located at the start position of the feature sequence; and if the first feature is not at the end position of the feature sequence and is not at the start position of the feature sequence, take, as the second features, features adjacent to the first feature in the feature sequence.

In some embodiments, the second processing module 5432 is further configured to: perform group normalization processing on the first features to obtain first features subjected to the group normalization processing; and perform channel shuffle processing on channels of the first features subjected to the group normalization processing to obtain the first processing result of the first features.

In some embodiments, the third processing module 5433 is further configured to: if a plurality of the second features exist, perform fusion processing on the first processing result and each second processing result respectively to obtain the third feature corresponding to each of the second features; and the third processing module 5433 is further configured to: map the third feature corresponding to each of the second features to a same feature space as the first feature to obtain the fourth feature of each second feature corresponding to the first feature.

In some embodiments, the fusion module 5434 is further configured to: perform fusion processing on the first features to obtain a sixth feature; perform mapping processing on the sixth feature to obtain a first mapping result; and perform normalization processing on the first mapping result to obtain a weight corresponding to each of the first features.

In some embodiments, the fusion module 5434 is further configured to: perform fusion processing on the fourth features corresponding to the first features and the first features to obtain ninth features corresponding to the first features; and perform weighting processing on the ninth features corresponding to the first features based on weights of the first features to obtain the fifth feature.

In some embodiments, the generation module 5435 is further configured to: perform mapping processing on the fifth feature to obtain a second mapping result, and perform vectorization processing on the first text to obtain a seventh feature; and perform fusion processing on the second mapping result and the seventh feature to obtain an eighth feature, and generate the second text based on the eighth feature.

It is to be noted that the description of the apparatus according to embodiments of the disclosure is similar to the description of the above-described method embodiments, and has similar beneficial effects as those of the method embodiments, so the description thereof will not be repeated. Technical details not described in the text generation device provided by the embodiments of the disclosure can be understood according to the description of any one of FIG. 4, FIG. 5, or FIG. 6.

An embodiment of the disclosure provides a computer program product comprising computer programs or computer-executable instructions stored in a computer-readable storage medium. The processor of the electronic device reads the computer-executable instruction from the computer-readable storage medium, and the processor executes the computer-executable instruction to cause the electronic device to perform the above-described text generation method according to the embodiments of the disclosure.

An embodiment of the disclosure provides a computer-readable storage medium storing computer-executable instructions or computer programs that, when executed by a processor, cause the processor to perform the text generation method according to the embodiments of the disclosure, for example, a text generation method shown in FIG. 4, FIG. 5, or FIG. 6.

In some embodiments, the computer-readable storage medium may be a memory such as a Ferroelectric Random Access Memory (FRAM), an ROM, a Programmable read-only Memory (PROM), an Erasable Programmable Read-Only Memory (EPROM), an Electrically Erasable Programmable Read-Only Memory (EEPROM), a flash memory, a magnetic surface memory, an optical disc, or a Compact Disc Read-Only Memory (CD-ROM). It may also be any one of a variety of devices including one or any combination of the memories described above.

In some embodiments, the computer-executable instructions may be in the form of programs, software, software modules, scripts, or code, written in any form of programming language (which includes compiled or interpreted languages, or declarative or procedural languages), and may be deployed in any form, which includes being deployed as a standalone program or as a module, component, subroutine, or another unit suitable for use in a computing environment.

As an example, the executable instructions may, but do not necessarily, correspond to files in a file system, and may be stored in a part of the file for saving other programs or data, for example, stored in one or more scripts in a hyper text markup language (HTML) document, in a single file specifically used for the program of interest, or in a plurality of collaborative files (for example, files storing one or more modules, submodules, or code parts).

As an example, the executable instructions may be deployed to be executed on a single electronic device, or on a plurality of electronic devices located in a single location, or on a plurality of electronic devices distributed in a plurality of locations and interconnected through a communication network.

In the embodiments of the disclosure, the first image is scaled in different proportions, multi-scale second images are generated, and feature extraction is performed on each second image to obtain features of each second image, it is thus possible to capture multi-granularity information of the image and avoid loss of single-scale information. Then, channel shuffle processing is performed on channels of first feature to obtain a first processing result of the first features, and channel shuffle processing is performed on channels of the second feature to obtain a second processing result of a second feature, where the first feature is a feature of any one of the second images, and the second feature is a feature different from the first feature among the features of the second image. By shuffling the order of channels of the features, the independence of features between the channels can be broken, and the feature information between different channels can be communicated and fused with each other, thereby mining potential relations between the features. Subsequently, fusion processing is performed on the first processing result and the second processing result to obtain a third feature, it is thus possible to describe the feature more comprehensively and accurately, enhance the expression ability of the feature; and the third feature is mapped to a same feature space as the first feature to obtain fourth features corresponding to the first features, which can ensure consistency and compatibility of the features. Then, fusion processing is performed on the fourth features corresponding to the first features according to weights of the first features to obtain a fifth feature, which integrates association of cross-scale information and improves the information expression ability of the feature. Finally, a second text that is more reasonably accurate is generated according to the fifth feature and a first text. To sum up, through multi-scale processing, cross-scale association, and weight-based fusion, it is possible to significantly improve the ability to capture image details in complex visual question answering tasks, thereby further improving the accuracy of cross-modal reasoning.

The foregoing descriptions are merely embodiments of the disclosure and are not intended to limit the protection scope of the disclosure. Any modification, equivalent replacement, or improvement made without departing from the spirit and scope of the disclosure shall fall within the protection scope of the disclosure.

1. A text generation method, comprising:
performing multi-scale scaling processing on a first image to obtain a plurality of second images, and performing feature extraction processing on each of the second images to obtain features of each of the second images;
performing channel shuffle processing on channels of first features to obtain a first processing result of the first features, and performing channel shuffle processing on channels of a second feature to obtain a second processing result of the second feature,
wherein the first feature is a feature of any one of the second images, and the second feature is a feature different from the first feature among the features of the second image;
performing fusion processing on the first processing result and the second processing result to obtain a third feature, and mapping the third feature to a same feature space as the first feature to obtain fourth features corresponding to the first features;
performing fusion processing on the fourth features corresponding to the first features based on weights of the first features to obtain a fifth feature; and
generating a second text based on the fifth feature and a first text corresponding to the first image.

2. The method of claim 1, wherein the performing feature extraction processing on each of the second images to obtain features of each of the second images comprises:
for each of the second images, invoking a first neural network corresponding to a size of the second image to perform feature extraction processing on the second image to obtain the features of the second image,
wherein a spatial complexity of the first neural network is negatively correlated with the size of the second image.

3. The method of claim 1, further comprising: before the performing channel shuffle processing on channels of a second feature to obtain a second processing result of the second feature,
performing sorting processing on features of the plurality of second images based on sizes of the plurality of second images to obtain a feature sequence;
if the first feature is located at a start position of the feature sequence, taking, as the second features, a feature adjacent to the first feature in the feature sequence and a feature located at an end position of the feature sequence;
if the first feature is located at the end position of the feature sequence, taking, as the second features, a feature adjacent to the first feature in the feature sequence and a feature located at the start position of the feature sequence; and
if the first feature is not at the end position of the feature sequence and is not at the start position of the feature sequence, taking, as the second features, features adjacent to the first feature in the feature sequence.

4. The method of claim 1, wherein the performing channel shuffle processing on channels of first features to obtain a first processing result of the first features comprises:
performing group normalization processing on the first features to obtain first features subjected to the group normalization processing; and
performing channel shuffle processing on channels of the first features subjected to the group normalization processing to obtain the first processing result of the first features.

5. The method of claim 1, further comprising: before the performing fusion processing on the fourth features corresponding to the first features based on weights of the first features to obtain a fifth feature,
performing fusion processing on the first features to obtain a sixth feature;
performing mapping processing on the sixth feature to obtain a first mapping result; and
performing normalization processing on the first mapping result to obtain a weight corresponding to each of the first features.

6. The method of claim 1, wherein the generating a second text based on the fifth feature and a first text corresponding to the first image comprises:
performing mapping processing on the fifth feature to obtain a second mapping result, and performing vectorization processing on the first text to obtain a seventh feature; and
performing fusion processing on the second mapping result and the seventh feature to obtain an eighth feature, and generating the second text based on the eighth feature.

7. The method of claim 1, wherein the performing fusion processing on the fourth features corresponding to the first features based on weights of the first features to obtain a fifth feature comprises:
performing fusion processing on the fourth features corresponding to the first features and the first features to obtain ninth features corresponding to the first features; and
performing weighting processing on the ninth features corresponding to the first features based on weights of the first features to obtain the fifth feature.

8. The method of claim 1, wherein the performing fusion processing on the first processing result of the first features and the second processing result of the second feature to obtain a third feature comprises:
if a plurality of the second features exist, perform fusion processing on the first processing result and each second processing result respectively to obtain the third feature corresponding to each of the second features,
wherein the mapping the third feature to a same feature space as the first feature to obtain fourth features corresponding to the first features comprises:
mapping the third feature corresponding to each of the second features to a same feature space as the first feature to obtain the fourth feature of each second feature corresponding to the first feature.

9. An electronic device, comprising:
a memory, configured to store computer-executable instructions or computer programs; and
a processor, configured to execute the computer-executable instructions or computer programs stored in the memory to perform operations of:
performing multi-scale scaling processing on a first image to obtain a plurality of second images, and performing feature extraction processing on each of the second images to obtain features of each of the second images;
performing channel shuffle processing on channels of first features to obtain a first processing result of the first features, and performing channel shuffle processing on channels of a second feature to obtain a second processing result of the second feature,
wherein the first feature is a feature of any one of the second images, and the second feature is a feature different from the first feature among the features of the second image;
performing fusion processing on the first processing result and the second processing result to obtain a third feature, and mapping the third feature to a same feature space as the first feature to obtain fourth features corresponding to the first features;
performing fusion processing on the fourth features corresponding to the first features based on weights of the first features to obtain a fifth feature; and
generating a second text based on the fifth feature and a first text corresponding to the first image.

10. The electronic device of claim 9, wherein the performing feature extraction processing on each of the second images to obtain features of each of the second images comprises:
for each of the second images, invoking a first neural network corresponding to a size of the second image to perform feature extraction processing on the second image to obtain the features of the second image,
wherein a spatial complexity of the first neural network is negatively correlated with the size of the second image.

11. The electronic device of claim 9, wherein the processor is configured to execute computer-executable instructions or computer programs stored in the memory to perform further operations of: before the performing channel shuffle processing on channels of a second feature to obtain a second processing result of the second feature,
performing sorting processing on features of the plurality of second images based on sizes of the plurality of second images to obtain a feature sequence;
if the first feature is located at a start position of the feature sequence, taking, as the second features, a feature adjacent to the first feature in the feature sequence and a feature located at an end position of the feature sequence;
if the first feature is located at the end position of the feature sequence, taking, as the second features, a feature adjacent to the first feature in the feature sequence and a feature located at the start position of the feature sequence; and
if the first feature is not at the end position of the feature sequence and is not at the start position of the feature sequence, taking, as the second features, features adjacent to the first feature in the feature sequence.

12. The electronic device of claim 9, wherein the performing channel shuffle processing on channels of first features to obtain a first processing result of the first features comprises:
performing group normalization processing on the first features to obtain first features subjected to the group normalization processing; and
performing channel shuffle processing on channels of the first features subjected to the group normalization processing to obtain the first processing result of the first features.

13. The electronic device of claim 9, wherein the processor is configured to execute computer-executable instructions or computer programs stored in the memory to perform further operations of: before the performing fusion processing on the fourth features corresponding to the first features based on weights of the first features to obtain a fifth feature,
performing fusion processing on the first features to obtain a sixth feature;
performing mapping processing on the sixth feature to obtain a first mapping result; and
performing normalization processing on the first mapping result to obtain a weight corresponding to each of the first features.

14. The electronic device of claim 9, wherein the generating a second text based on the fifth feature and a first text corresponding to the first image comprises:
performing mapping processing on the fifth feature to obtain a second mapping result, and performing vectorization processing on the first text to obtain a seventh feature; and
performing fusion processing on the second mapping result and the seventh feature to obtain an eighth feature, and generating the second text based on the eighth feature.

15. The electronic device of claim 9, wherein the performing fusion processing on the fourth features corresponding to the first features based on weights of the first features to obtain a fifth feature comprises:
performing fusion processing on the fourth features corresponding to the first features and the first features to obtain ninth features corresponding to the first features; and
performing weighting processing on the ninth features corresponding to the first features based on weights of the first features to obtain the fifth feature.

16. The electronic device of claim 9, wherein the performing fusion processing on the first processing result of the first features and the second processing result of the second feature to obtain a third feature comprises:
if a plurality of the second features exist, perform fusion processing on the first processing result and each second processing result respectively to obtain the third feature corresponding to each of the second features,
wherein the mapping the third feature to a same feature space as the first feature to obtain fourth features corresponding to the first features comprises:
mapping the third feature corresponding to each of the second features to a same feature space as the first feature to obtain the fourth feature of each second feature corresponding to the first feature.

17. A non-transitory computer-readable storage medium having stored thereon computer-executable instructions or computer programs that, when executed by a processor, cause the processor to perform operations of:
performing multi-scale scaling processing on a first image to obtain a plurality of second images, and performing feature extraction processing on each of the second images to obtain features of each of the second images;
performing channel shuffle processing on channels of first features to obtain a first processing result of the first features, and performing channel shuffle processing on channels of a second feature to obtain a second processing result of the second feature,
wherein the first feature is a feature of any one of the second images, and the second feature is a feature different from the first feature among the features of the second image;
performing fusion processing on the first processing result and the second processing result to obtain a third feature, and mapping the third feature to a same feature space as the first feature to obtain fourth features corresponding to the first features;
performing fusion processing on the fourth features corresponding to the first features based on weights of the first features to obtain a fifth feature; and
generating a second text based on the fifth feature and a first text corresponding to the first image.

18. The storage medium of claim 17, wherein the performing feature extraction processing on each of the second images to obtain features of each of the second images comprises:
for each of the second images, invoking a first neural network corresponding to a size of the second image to perform feature extraction processing on the second image to obtain the features of the second image,
wherein a spatial complexity of the first neural network is negatively correlated with the size of the second image.

19. The storage medium of claim 17, wherein the processor is caused to perform further operations of: before the performing channel shuffle processing on channels of a second feature to obtain a second processing result of the second feature,
performing sorting processing on features of the plurality of second images based on sizes of the plurality of second images to obtain a feature sequence;
if the first feature is located at a start position of the feature sequence, taking, as the second features, a feature adjacent to the first feature in the feature sequence and a feature located at an end position of the feature sequence;
if the first feature is located at the end position of the feature sequence, taking, as the second features, a feature adjacent to the first feature in the feature sequence and a feature located at the start position of the feature sequence; and
if the first feature is not at the end position of the feature sequence and is not at the start position of the feature sequence, taking, as the second features, features adjacent to the first feature in the feature sequence.

20. The storage medium of claim 17, wherein the performing channel shuffle processing on channels of first features to obtain a first processing result of the first features comprises:
performing group normalization processing on the first features to obtain first features subjected to the group normalization processing; and
performing channel shuffle processing on channels of the first features subjected to the group normalization processing to obtain the first processing result of the first features.
